(19) United States
(12) Patent Application Publication
(10) Pub. No.: US 2010/0037143 A1
(43) Pub. Date: Feb. 11, 2010

(54) SYSTEM AND METHOD FOR UPDATING OF REMOTE DOCUMENT PROCESSING DEVICES

(76) Inventor: Marianne L. KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/187,855

(22) Filed: Aug. 7, 2008

(51) Int. Cl. G06F 3/01

(52) U.S. Cl. 715/739

(57) ABSTRACT

The subject application is directed to a system and method for remote document processing device administration. Administrative data is communicated between an administrative thin client and a plurality of document processing devices, the administrative data including identifier data, status data, and corresponding configuration data for each document processing device. A display corresponding to the document processing devices is generated on the administrative thin client in accordance with received administrative data. Selection data is received corresponding to at least one document processing device selected in accordance with document processing devices on the display. Each selected document processing device is polled for updated administrative data in accordance with activation of the selection means, and a detail listing of at least one of status data and configuration data is generated for each selected document processing device.

### BACKGROUND OF THE INVENTION

The subject application is directed generally to remote device administration. The application is particularly applicable to remote monitoring or control of document processing devices by administrators operating via remote systems, such as administrative terminals that may be operable via a thin client interface.

Document processing devices in common use today include copiers, printers, and facsimile machines, as well as devices having more than one such function. These latter devices are frequently referred to as multifunction peripherals (MFPs) or multifunction devices (MFDs).

Many enterprises employ two or more document processing devices that are connected to a data network such as a local area network, a wide area network, or the Internet. Often, devices are spread to many locations, which may include different floors of a building or even different buildings. Administrators frequently rely on remote connection to such devices to determine device status, configuration, workload, and the like.

### SUMMARY OF THE INVENTION

In accordance with one embodiment of the subject application, there is provided a system and method for remote document processing device administration. Administrative data is communicated between an administrative thin client and a plurality of document processing devices, the administrative data including identifier data, status data, and corresponding configuration data for each document processing device. A display corresponding to the document processing devices is generated on the administrative thin client in accordance with received administrative data. Selection data is received corresponding to at least one document processing device selected in accordance with document processing devices on the display. Each selected document processing device is polled for updated administrative data in accordance with activation of the selection means, and a detail listing of at least one of status data and configuration data is generated for each selected document processing device.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a remote document processing device administration system according to one embodiment of the subject application;

FIG. 2 is a block diagram illustrating device hardware for use in the remote document processing device administration system according to one embodiment of the subject application:

FIG. 3 is a functional diagram illustrating the device for use in the remote document processing device administration system according to one embodiment of the subject application;

FIG. 4 is a block diagram illustrating controller hardware for use in the remote document processing device administration system according to one embodiment of the subject application;

FIG. 5 is a functional diagram illustrating the controller for use in the remote document processing device administration system according to one embodiment of the subject application;

FIG. 6 is a functional diagram illustrating a user device for use in the remote document processing device administration system according to one embodiment of the subject application:

FIG. 7 is a functional diagram illustrating the remote document processing device administration system according to one embodiment of the subject application;

FIG. 8 is a flowchart illustrating a remote document processing device administration method according to one embodiment of the subject application; and

FIG. 9 is a flowchart illustrating a remote document processing device administration method according to one embodiment of the subject application.

### DETAILED DESCRIPTION OF THE PREFERRED EMBODIMENT

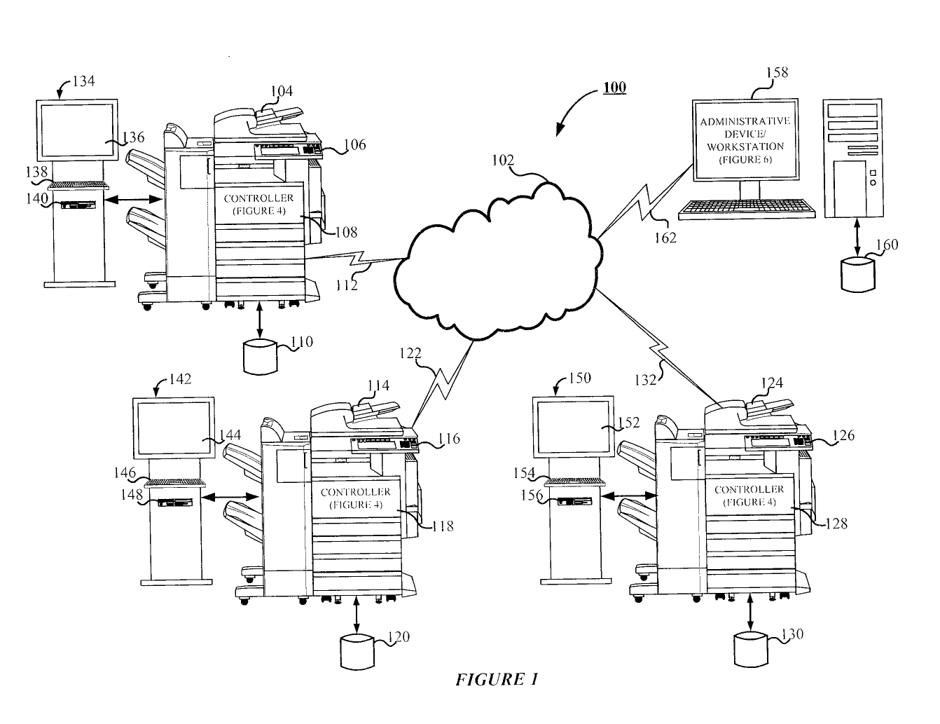

The subject application is directed to a system and method for remote device administration. In particular, the subject application is directed to a system and method for remote monitoring or control of document processing devices by administrators via remote systems, such as administrative terminals that may be operable via a thin client interface. It will become apparent to those skilled in the art that the system and method described herein are suitably adapted to a plurality of varying electronic fields employing remote device interactions including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a remote document processing device administration system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also comprises one or more document processing devices, depicted in FIG. 1 as the document processing devices 104, 114, and 124. As shown in FIG. 1, the document processing devices 104, 114, and 124 are illustrated as multifunction peripheral devices suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, or any suitable combination thereof configured to interact with an associated user, a networked device, or the like.

According to one embodiment of the subject application, the document processing devices 104, 114, and 124 are suitably equipped to receive a plurality of portable storage media including, without limitation, Firewire drive, USB drive, SD, MMC, XD, compact flash, memory stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the Subject application, the user interfaces 106, 116, and 126 are advantageously used to communicate information to associated users and receive selections from such associated users.

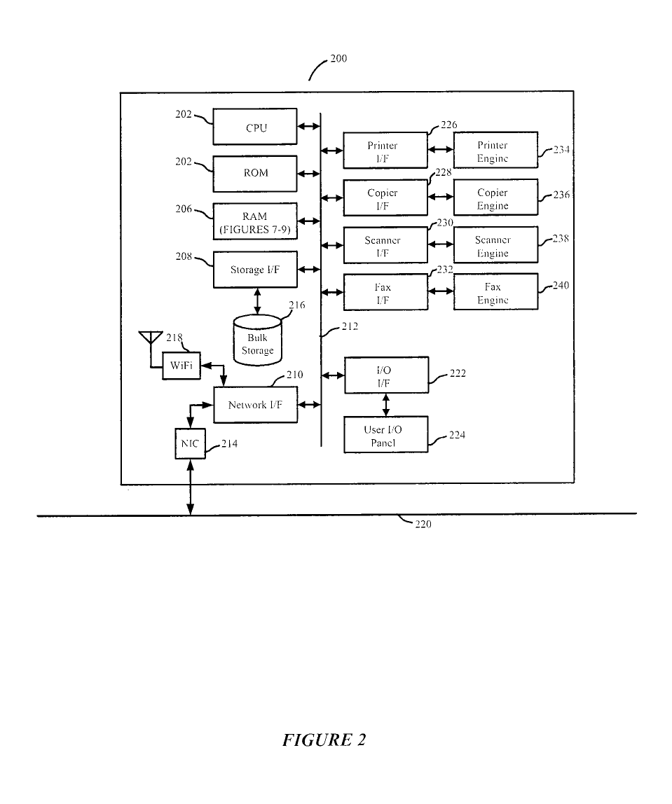

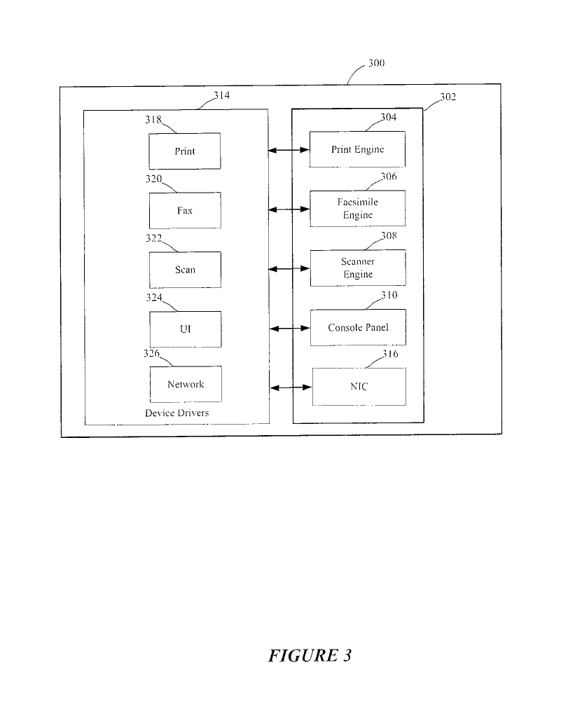

The skilled artisan will appreciate that the user interfaces 106, 116, and 126 comprise various components suitably adapted to present data to associated users, as are known in the art. In accordance with one embodiment of the subject application, the user interfaces 106, 116, and 126 comprise a display suitably adapted to display one or more graphical elements, text data, images, or the like to an associated user, to receive input from the associated user, and to communicate the same to a backend component such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

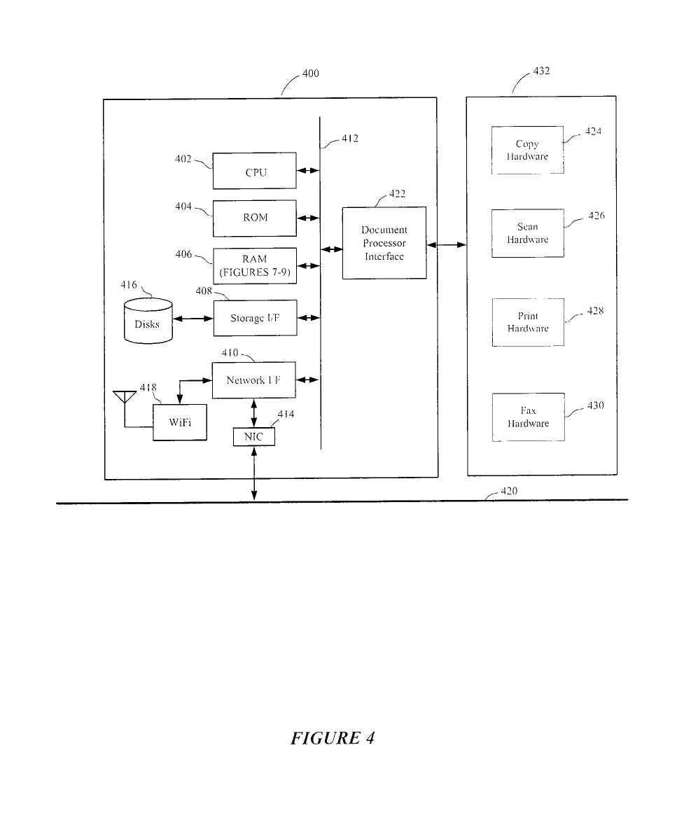

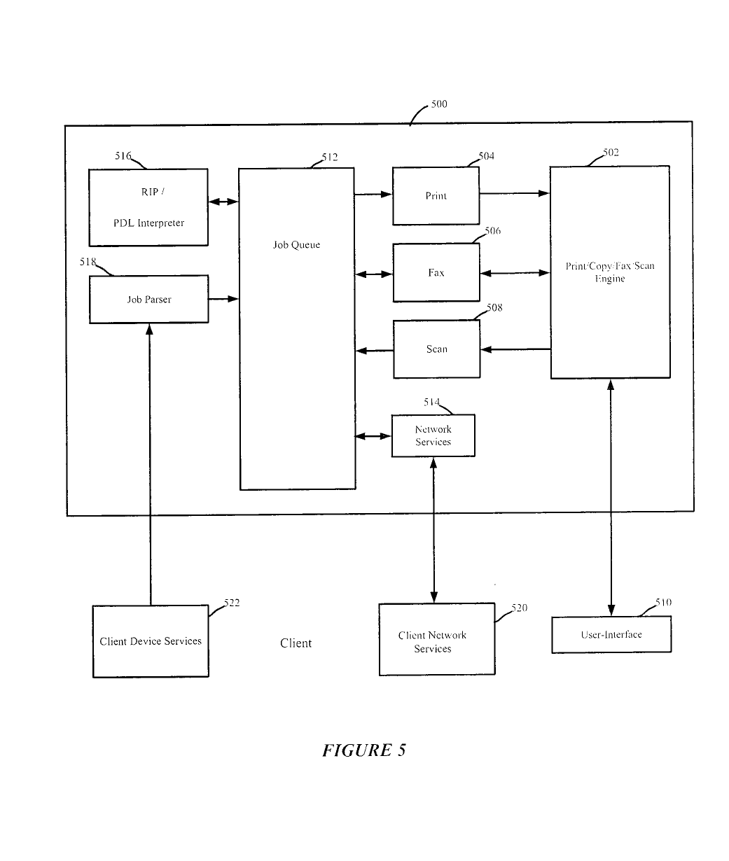

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof configured to control the operations of the associated document processing devices 104, 114, and 124, facilitate the display of images via the user interfaces 106, 116, and 126, direct the manipulation of electronic image data, and the like. For purposes of explanation, the controllers 108, 118, and 128 are used to refer to any of the myriad components associated with the document processing devices 104, 114, and 124, including hardware, software, or combinations thereof functioning to perform, cause to be performed, control, or otherwise direct the methodologies described hereinafter. It will be understood by those skilled in the art that the methodologies described with respect to the controllers 108, 118, and 128 are capable of being performed by any general purpose computing system known in the art, and thus the controllers 108, 118, and 128 are representative of such a general computing device and are intended as such when used hereinafter. Furthermore, the use of the controllers 108, 118, and 128 hereinafter is for the example embodiment only, and other embodiments, which will be apparent to one skilled in the art, are capable of employing the system and method for remote document processing device administration of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store document data, image data, electronic database data, or the like. It will be appreciated by those skilled in the art that, while illustrated in FIG. 1 as being separate components of the system 100, the data storage devices 110, 120, and 130 are capable of being implemented as internal storage components of the document processing devices 104, 114, and 124; components of tile controllers 108, 118, and 128; or the like such as, for example and without limitation, an internal hard disk drive or the like.

Illustrated in FIG. 1 are a first kiosk 134 communicatively coupled to the first document processing device 104 and, in effect, the computer network 102; a second kiosk 142 communicatively coupled to the second document processing device 114 and, in effect, the computer network 102; a third kiosk 150 communicatively coupled to the third document processing device 124 and, in effect, the computer network 102. It will be appreciated by those skilled in the art that the kiosks 134, 142, and 150 are capable of being implemented as separate components of the respective document processing devices 104, 114, and 124 or as integral components thereof. Use of the kiosks 134, 142, and 150 in FIG. 1 are for example purposes only, and the skilled artisan will appreciate that the subject application is capable of implementation without the use of kiosks 134, 142, and 150. In accordance with one embodiment of the subject application, the kiosks 134, 142, and 150 include respective displays 136, 144, and 152 and user input devices 138, 146, and 154. As will be understood by those skilled in the art, the kiosks 134, 142, and 150 are capable of implementing a combination user input device/display, such as a touch screen interface. According to one embodiment of the subject application, the kiosks 134, 142, and 150 are suitably adapted to display selected advertisements to prospective customers, to display prompts to an associated user, to receive instructions from the associated user, to receive payment data, to receive selection data from the associated user, and the like. Preferably, the kiosks 134, 142, and 150 include a magnetic card reader, conventional bar code reader, or the like suitably adapted to receive and read payment data from a credit card, coupon, debit card, or the like.

The system 100 of FIG. 1 also includes portable storage device readers 140, 148, and 156 coupled to the kiosks 134, 142, and 150 and suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

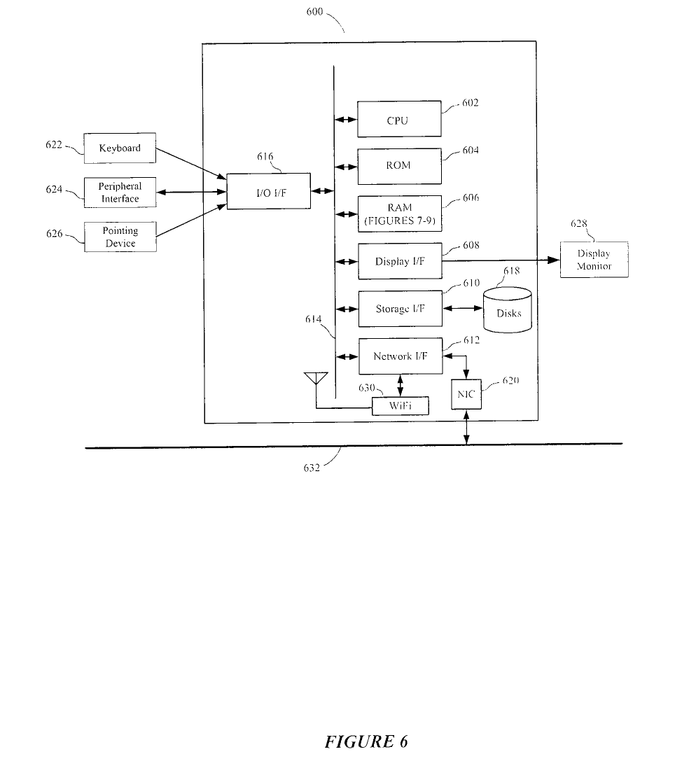

The system 100 illustrated in FIG. 1 further depicts an administrative terminal 158 in data communication with the computer network 102 via a communications link 162. It will be appreciated by those skilled in the art that the administrative terminal 158 is shown in FIG. 1 as a computer workstation for illustration purposes only. As will be understood by those skilled in the art, the administrative terminal 158 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 162 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative terminal 158 is suitably adapted to monitor operations of the computer network 102, the document processing devices 104, 114, and 124 or any other similar device coupled to the computer network 102, and the like. According to one embodiment of the subject application, the administrative terminal 158 is suitably configured to employ a thin client interface, e.g. a web-browser, dedicated software application, dedicated hardware, or the like, via which an associated administrative user is capable of monitoring device status, configurations, workloads, and the like; provide such devices with operating or configuration instructions; and the like. The functioning of the administrative terminal 158 will better be understood in conjunction with the block diagram illustrated in FIG. 6, explained in greater detail below.

Communicatively coupled to the administrative terminal 158 is the data storage device 160. In accordance with the preferred embodiment of the subject application, the data storage device 160 is any mass storage device, or a plurality of such devices, known in the art including for example and without limitation, magnetic storage drives, a hard disk drive, optical storage devices, flash memory devices, or any suitable combination thereof. According to one embodiment of the subject application, the data storage device 160 is suitably adapted to store device status data, device configuration data, workload data, electronic documents, administrative policies, image data, account data, user data, and the like. It will be appreciated by those skilled in the art that, while illustrated in FIG. 1 as being a separate component of the system 100, the data storage device 160 is capable of being implemented as an internal storage component of the administrative terminal 158 or the like such as, for example and without limitation, an internal hard disk drive or the like.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. Tile network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228. scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network, via driver 326, suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface is functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device known in the art that is capable of facilitating the methodologies described herein. Included is a processor 402 suitably comprised of a central processor unit; however, it will be appreciated that processor 402 may advantageously be composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104, 114, and 124, which includes the controller 400 of FIG. 4 (shown in FIG. 1 as the controllers 108, 118, and 128) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms such as bit map, page description language or vector format, and the like are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol., uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative terminal 158, for use in connection with the subject system. A suitable workstation 600 includes a processor unit 602, which is advantageously placed in data communication with read only memory 604, suitably non-volatile read only memory, volatile read only memory, or a combination thereof; random access memory 606; display interface 608; storage interface 610; and network interface 612. In a preferred embodiment, interface to the foregoing modules is suitably accomplished via a bus 614.

The read only memory 604 suitably includes firmware such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. Tile display interface 608 suitably provides output to a display terminal 628, suitably a video display device such as a monitor, LCD, plasma, or any other suitable visual output device, as will be appreciated by one of ordinary skill in the art.

The storage interface 610 suitably provides a mechanism for non-volatile, bulk, or long-term storage of data or instructions in the workstation 600. The storage interface 610 suitably uses a storage mechanism, such as storage 618, suitably comprised of a disk, tape, CD, DVD, or other relatively higher-capacity addressable or serial storage medium.

The network interface 612 suitably communicates to at least one other network interface, shown as network interface 620, such as a network interface card, and wireless network interface 630, such as a WiFi wireless network card. It will be appreciated by one of ordinary skill in the art that a suitable network interface is comprised of both physical and protocol layers and is suitably any wired system, such as Ethernet, Token-Ring, or any other wide area or local area network communication system or wireless system, such as WiFi, WiMax, or any other suitable wireless network system. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622 such as a keyboard or the like. The input/output interface 616 also suitably provides data output to a peripheral interface 624 such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices such as a mouse, light pen, touch screen, or the like.

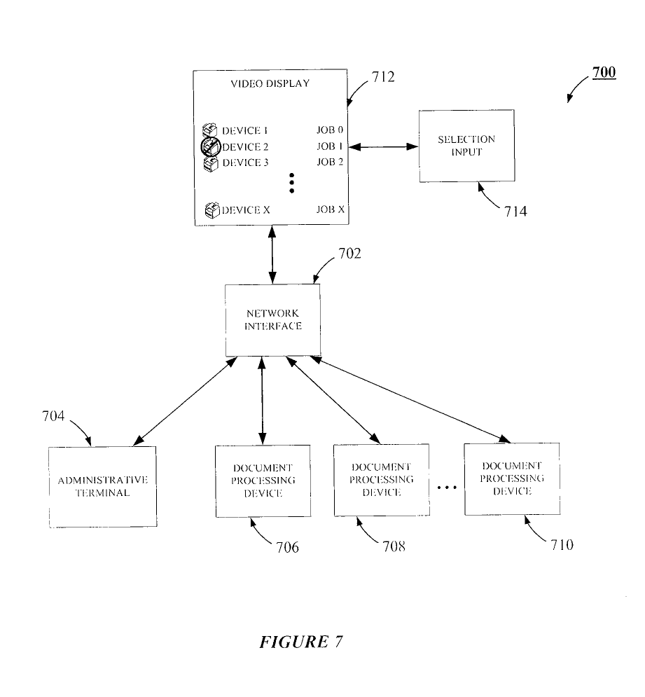

Turning now to FIG. 7, illustrated is a functional diagram of a system 700 for remote document processing device administration in accordance with one embodiment of the subject application. As shown in FIG. 7, the system 700 includes a network interface 702 enabling bidirectional communication between an administrative terminal 704 and a plurality of document processing devices 706, 708, and 710. Preferably, the network interface 702 enables the communication of administrative data between the administrative terminal 704 and each of the document processing devices 706, 708, and 710. In accordance with one embodiment of the subject application, the administrative data includes, for example and without limitation, identifier data, status data, configuration data corresponding to each device 706, 708, and 710, and the like.

The system 700 further includes a video display 712 displaying a listing of each of the document processing devices 706, 708, and 710 based upon the associated administrative data. The system 700 also comprises a selection input 714 for device selection data corresponding to at least one of the document processing devices 706, 708, and/or 710 from the displayed listing. According to one embodiment of the subject application, the video display 712 includes a listing of details associated with each of the selected document processing devices 706, 708, and/or 710 including, for example and without limitation, configuration data and status data dynamically updated from administration data upon receipt of the selection data from the selection input 714. The skilled artisan will appreciate that one example embodiment of the subject application includes the video display 712 and the selection input 714 as a components of the administrative terminal 704, whereby the administrative terminal 704 is capable of displaying the administrative data associated with each selected document processing device 706, 708, and/or 710.

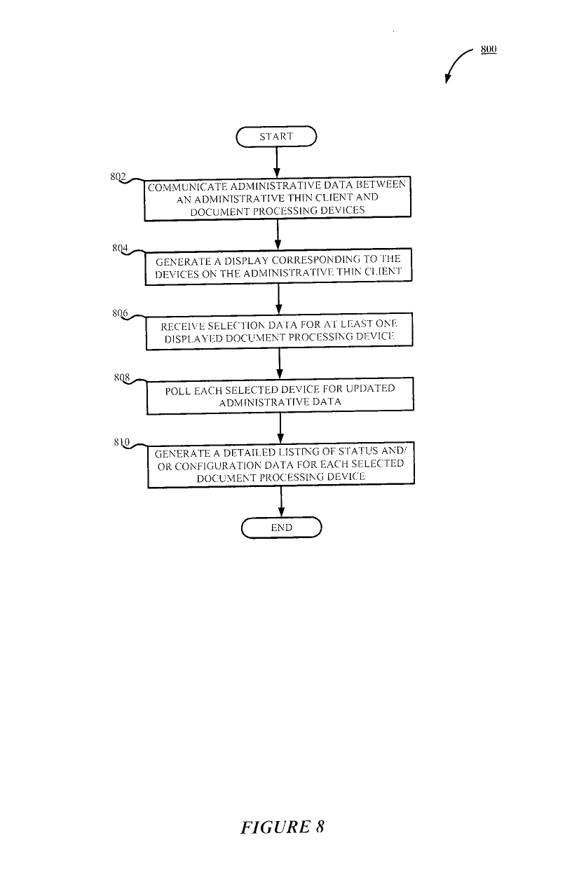

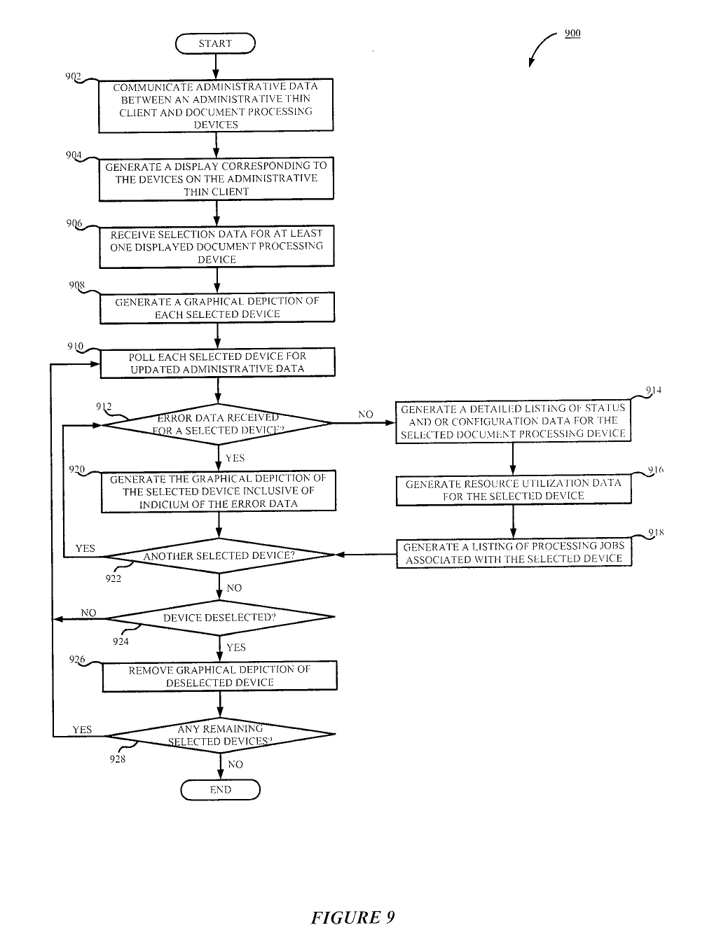

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for remote document processing device administration in accordance with one embodiment of the subject application. Beginning at step 802, administrative data is communicated between an administrative thin client and a plurality of document processing devices 104, 114, and 124. According to one example embodiment of the subject application, the administrative thin client is resident on the administrative terminal 158 and suitably configured to interact with the computer network 102, thereby enabling communications with the various devices coupled to the computer network 102, e.g. the document processing devices 104, 114, and 124. The skilled artisan will appreciate that the administrative data includes, for example and without limitation, identifier data, status data, and corresponding configuration data for each of the document processing devices 104, 114, and 124. It will also be appreciated by those skilled in the art that the thin client is capable of including, for example and without limitation, a web browser, software application, hardware, or any suitable combination thereof. In accordance with one example embodiment of the subject application, the thin client is implemented as a web browser on the administrative terminal 158, e.g. INTERNET EXPLORER, SAFARI, MOZILLA, FIREFOX, OPERA, NETSCAPE, FLOCK, or other suitable software application enabling user interaction with web pages.

At step 804, a display is generated on the administrative thin client corresponding to the document processing devices 104, 114, and 124 based upon the received administrative data. In accordance with one embodiment of the subject application, the display includes a listing of all document processing devices 104, 114, and 124 in data communication with the computer network 102 that communicated administrative data to the administrative terminal 158. Selection data is then received at step 806 for at least one document processing device 104, 114, or 124 selected in accordance with the document processing devices 104, 114, and 124 displayed on the thin client of the administrative terminal 158. Stated another way, a user associated with the administrative terminal 158 selects at least one of the document processing devices 104, 114, or 124 via the thin client interface, e.g. via a graphical user interface displayed on the administrative terminal 158.

The administrative terminal 158, via the associated administrative thin client, then polls each of the selected document processing devices 104, 114, or 124 at step 808 for updated administrative data. That is, the administrative terminal 158 polls each of the document processing devices 104, 114, and/or 124 selected by the administrative user for updated configuration data, status data, job processing data, resource utilization data, or the like. A detail listing of the selected document processing devices 104, 114, and/or 124 selected by the administrative user is then generated on the thin client of the administrative terminal 158 at step 810. In accordance with one embodiment of the subject application, the detail listing includes the updated configuration, status, resource utilization, job processing, and other such data associated with the selected document processing devices 104, 114, and/or 124.

Referring now to FIG. 9, there is shown a flowchart 900 illustrating a method for remote document processing device administration in accordance with one embodiment of the subject application. The methodology of FIG. 9 begins at step 902, whereupon the controllers 108, 118, and 128 or other suitable components associated with the document processing devices 104, 114, and 124 communicate administrative data to an administrative thin client resident on the administrative terminal 158. In accordance with one embodiment of the subject application, the administrative data is communicated to the administrative terminal 158 in accordance with a request from the thin client to each of the document processing devices 104, 114, and 124, automatically by each document processing device 104, 114, and 124, or a suitable combination thereof. According to one embodiment of the subject application, the administrative data includes, for example and without limitation, identifier data, status data, configuration data, and the like. It will appreciated by those skilled in the art that the depiction and use of three document processing devices 104, 114, and 124 is for example purposes only, and any number of document processing devices are capable of being remotely administered in accordance with the subject application.

A display is then generated at step 904 corresponding to the document processing devices 104, 114, and 124 that communicated administrative data via the thin client of the administrative terminal 158. The skilled artisan will appreciate that any suitable thin client is capable of being implemented in accordance with the methodology depicted in FIG. 9 including, for example and without limitation, a web browser. Suitable web browsers include, for example and without limitation, INTERNET EXPLORER, SAFARI, MOZILLA, FIREFOX, OPERA, NETSCAPE, FLOCK, or other suitable software application enabling user interaction with web pages.

At step 906, selection data is received from a user associated with the administrative terminal 158 via the thin client for at least one displayed document processing device 104, 114, and/or 124. That is, the user selects, via the administrative thin client, one or more document processing devices 104, 114, and/or 124 using a suitable graphical user interface. A graphical depiction of each selected document processing device 104, 114, and/or 124 is then generated at step 908 on the thin client of the administrative terminal 158. It will be appreciated by those skilled in the art that such a graphical representation includes, for example and without limitation, an image of the corresponding device, an icon of the corresponding device, or the like. Each of the selected document processing devices 104, 114, and/or 124 is then polled at step 910 for updated administrative data, e.g. status, configuration, resource, and the like. Preferably, the controllers 108, 118, and/or 128 or other suitable components associated with the selected document processing devices 104, 114, and/or 124 collect and then communicate updated administrative data to the administrative terminal 158 via the computer network 102 in accordance with the polling operation performed at step 910.

A determination is then made at step 912 by the administrative terminal 158 as to whether error data was received from a selected document processing device 104, 114, or 124. That is, to the administrative terminal 158, via the associated thin client, analyzes the received updated administrative data to determine whether any of the received status data indicates that a malfunction or other such error has occurred with respect to any of the selected document processing devices 104, 114, and/or 124. For example, the status data is capable of indicating that a document processing device 104, 114, or 124 is out-of-paper, low of toner, has a paper jam, or the like.

When it is determined at step 912 that no error data has been received in association with the received updated administrative data for a selected device 104, 114, or 124, operations proceed to step 914. At step 914, the administrative terminal 158, via the administrative thin client, generates a detailed listing of status and/or configuration data associated with the selected document processing device. Resource utilization data is then generated at step 916 corresponding to the resources in use by the selected document processing device 104, 114, or 124. The skilled artisan will appreciate that resource utilization data includes, for example and without limitation, processing usage, toner usage, output medium usage, facsimile usage, storage capacity, and the like. At step 918, a listing of any document processing jobs associated with the selected document processing device 104, 114, or 124 is generated on the thin client associated with the administrative terminal 158. Thus, the skilled artisan will appreciate that a detailed listing, inclusive of a graphical representation of a selected device 104, 114, or 124 is displayed on the administrative thin client inclusive of pending document processing jobs, device status, device configuration, identifier information, resource utilization information, and the like.

Operations with respect to FIG. 9 then continue from step 918 to step 922, whereupon a determination is made as to whether any other selected devices 104, 114, or 124 remain to be detailed on the thin client of the administrative terminal 158. For example, when the selected document processing devices include all three devices 104, 114, and 124 illustrated in FIG. 1, the updated administrative data corresponding to the first document processing device 104 is detailed on the thin client of the administrative terminal 158 from steps 912 through 918 as set forth above. A determination is then made at step 922 as to whether another selected device remains for display of updated data, e.g. the second document processing device 114 and the third document processing device 124. Operations then return to step 912, whereupon the administrative terminal 158, via the thin client, determines whether the updated administrative data received from the second document processing device 114 includes error data indicative of a to malfunction of the second document processing device 114. Upon a determination at step 912 that error data was received with the updated administrative data from the second document processing device 114, flow proceeds to step 920. At step 920, the graphical depiction of the second document processing device 114 is generated inclusive of indicium of the error data. For example and without limitation, the graphical image of the second document processing device 114 is capable of being overlayed with an exclamation point, a warning sign, or other suitable indicia of errors associated with the device 114.

A determination is then made at step 922 as to whether another selected device remains to be displayed, e.g. the third document processing device 124. Operations then continue as set forth above for the third document processing device 124 with respect to steps 912 through 920. Upon a determination at step 922 that no additional document processing devices remain for display, flow proceeds to step 924, whereupon a determination is made as to whether any one of the displayed document processing devices 104, 114, or 124 has been deselected, i.e. removed from the thin client display of devices.

Upon a determination at step 924 that none of the displayed document processing devices 104, 114, or 124 has been deselected, flow returns to step 910, whereupon each of the selected devices 104, 114, and 124 are polled for updated administrative data. Operations then continue as set forth above with respect to steps 912 through 922 for each of the selected devices. When it is determined at step 924 that one or more of the displayed document processing devices 104, 114, and/or 124 have been deselected, flow proceeds to step 926. At step 926, the graphical representation associated with the deselected document processing device 104, 114, or 124 is removed from the display generated on the thin client of the administrative terminal 158. A determination is then made at step 928 by the administrative terminal 158 via the thin client as to whether any document processing devices 104, 114, or 124 remain selected and displayed. When one or more document processing devices 104, 114, and/or 124 remain displayed on the thin client of the administrative terminal 158, flow returns to step 910 for polling of updated administrative data. In the event that all previously selected document processing devices 104, 114, and 124 have been deselected, operations with respect to FIG. 9 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application, to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A remote document processing device administration system, comprising:
a network interface for bidirectional exchange of administrative data between an administrative terminal and a plurality of document processing devices, the administrative data including identifier data, status data, and corresponding configuration data for each document processing device;
a video display including a listing of each document processing device in accordance with the administrative data;
a selection input for device selection data corresponding to at least one document processing device from the plurality listed on the video display; and
the video display including a listing of details of each selected document processing device of at least one of configuration data and status data dynamically updated from administration data upon receipt of selection data from the selection input.

2. The system of claim 1, wherein the details in the listing include resource utilization for each selected device.

3. The system of claim 2, wherein the details further include a listing of document processing jobs associated with each selected document processing device.

4. The system of claim 3, further including a queue management input for queue management data associated with control of at least one of the document processing jobs.

5. The system of claim 1, wherein the details further include a graphical depiction of each selected device.

6. The system of claim 5, wherein the configuration data includes error data corresponding to a malfunction of at least one of the selected devices.

7. The system of claim 6, wherein the graphical depiction includes indicium corresponding to the error data.

8. A remote document processing device administration method, comprising the steps of:
communicating administrative data between an administrative thin client and a plurality of document processing devices, the administrative data including identifier data, status data, and corresponding configuration data for each document processing device;
generating, on the administrative thin client, a display corresponding to the document processing devices in accordance with received administrative data;
receiving selection data corresponding to at least one document processing device to selected in accordance with document processing devices on the display;
polling each selected document processing device for updated administrative data in accordance with received selection data; and
generating a detail listing of at least one of status data and configuration data for each selected document processing device.

9. The method of claim 8, further comprising the step of generating resource utilization data on the display for each selected device.

10. The method of claim 9, further comprising the step of generating a listing of document processing jobs associated with each selected device on the display.

11. The method of claim 10, wherein the administrative data includes management input received via the thin client for queue management data associated with control of at least one of the document processing jobs.

12. The method of claim 7, further comprising the step of generating a graphical depiction of each selected device on the thin client.

13. The method of claim 12, further comprising the step of receiving status data inclusive of error data corresponding to a malfunction of at least one of the selected devices.

14. The method of claim 13, further comprising the step of generating, on the thin client, the graphical depiction inclusive of indicium corresponding to the error data.

15. A remote document processing device administration system, comprising:
means adapted for communicating administrative data between an administrative thin client and a plurality of document processing devices, the administrative data including identifier data, status data, and corresponding configuration data for each document processing device;
a display generator adapted for generating, on the administrative thin client, a lo display corresponding to the document processing devices in accordance with received administrative data;
selection means adapted for receiving selection data corresponding to at least one document processing device selected in accordance with document processing devices on the display;
means adapted for polling each selected document processing device for updated administrative data in accordance with activation of the selection means; and
means adapted for generating a detail listing of at least one of status data and configuration data for each selected document processing device.

16. The system of claim 15, further comprising means adapted for generating resource utilization data on the display for each selected device.

17. The system of claim 16, further comprising means adapted for generating a listing of document processing jobs associated with each selected device on the display.

18. The system of claim 17, wherein the administrative data includes management input received via the thin client for queue management data associated with control of at least one of the document processing jobs.

19. The system of claim 15, further comprising means adapted for generating a graphical depiction of each selected device on the thin client.

20. The system of claim 19, further comprising means adapted for receiving status data inclusive of error data corresponding to a malfunction of at least one of the selected devices.
